(19) United States
(12) Patent Application Publication
(10) Pub. No.: US 2020/0040616 A1
(43) Pub. Date: Feb. 6, 2020

(54) Vehicle Handle Inertial Locking Structure

(71) Applicant: Ningbo Huade Automobile Parts Co., Ltd., Ningbo City (CN)

(72) Inventor: Weifei HU, Ningbo City (CN)

(21) Appl. No.: 16/432,908

(22) Filed: Jun. 5, 2019

(30) Foreign Application Priority Data
Jul. 31, 2018 (CN) 201810854845 .5

(51) Int. Cl. E05B 77/06; E05B 79/20; E05B 79/06

(52) U.S. Cl. CPC E05B 77/06; E05B 79/06; E05B 79/20

(57) ABSTRACT

A vehicle handle inertial locking structure includes a handle base, an inertial locking device located on the handle base, a handle unlocking device located on the handle base, and an unlocking pull rope. One end of the unlocking pull rope is connected to the handle unlocking device, and the other end is connected to an internal locking body of a vehicle. When the handle unlocking device rotates, the unlocking pull rope is pulled to implement the handle to unlock, thereby opening the vehicle door. The inertial locking device is provided with a first limiting protrusion, and the handle unlocking device is provided with a second limiting protrusion; when the inertial locking device rotates counterclockwise, the first limiting protrusion interferes with the second limiting protrusion; thus, the inertial locking device restricts the rotation of the handle unlocking device and cannot implement the handle to unlock.

### RELATED APPLICATIONS

This application claims priority to Chinese Patent Application No. 201810854845.5, having a filing date of Jul. 31, 2018, which is incorporated herein by reference in its entirety.

### TECHNICAL FIELD

The present disclosure relates to a vehicle field, and in particular to a vehicle handle inertial locking structure.

### BACKGROUND

As the development of the life level, more and more families purchase a car as a vehicle, and as the number of cars increases constantly, the probability of car accident is also increasing during driving.

When a strike occurs during the vehicle driving, the existing door may be stroked and the existing door may be probabilistically automatically opened, and the opening of the door is very dangerous during the high-speed driving, and therefore, a structure capable of stopping the opening of the door when the vehicle strike is required.

### SUMMARY

In order to overcome the disadvantages of the prior art, the present disclosure provides a vehicle handle inertial locking structure, which not only can prevent a vehicle from opening a door when a collision occurs, but can effectively protect the handle when a bottom bracing is folded.

The technical solution of the present disclosure for solving the technical problem thereof is: a vehicle handle inertial locking structure, comprising a handle base, and the vehicle handle inertial locking structure further includes an inertial locking device and a handle unlocking device, wherein the handle base is provided with a first bracket located on a left side and a second bracket located on a right side, and the inertial locking device is rotatably connected to the first bracket; the handle unlocking device is rotatably connected to the second bracket, and the vehicle handle inertial locking structure further includes an unlocking pull rope, wherein one end of the unlocking pull rope is connected to the handle unlocking device, and the other end is connected to an internal locking body of a vehicle; when the handle unlocking device rotates, the unlocking pull rope is pulled to implement an unlocking of a handle, thereby opening a vehicle door;

wherein the inertial locking device is provided with a first limiting protrusion, the handle unlocking device is provided with a second limiting protrusion, the first limiting protrusion corresponds to the second limiting protrusion, and when the inertial locking device rotates counterclockwise, the first limiting protrusion interferes with the second limiting protrusion; thus, the inertial locking device restricts a rotation of the handle unlocking device and cannot implement an unlocking of the handle.

In some embodiments, the inertial locking device includes an inertial locking body and a first torsion spring, wherein the inertial locking body is rotatably connected to the first bracket, and the first torsion spring is arranged on the inertial locking body.

In some embodiments, the inertial locking body is provided with a positioning shaft, the first torsion spring is provided on the positioning shaft in a sleeve manner, the first support is provided with a positioning hole, and the positioning shaft can be inserted into the positioning hole.

In some embodiments, the handle unlocking device includes an unlocking piece, a rotating shaft and a second torsion spring, wherein the unlocking piece is rotatably connected to the second bracket by the rotating shaft, the second torsion spring is provided on the rotating shaft in a sleeve manner, and a working end of the second torsion spring abuts against the unlocking piece.

When the vehicle door is normally opened, the inertial locking device is in a stationary state without an inertial action, and the handle unlocking device rotates to drive the unlocking rope to implement the unlocking of the handle, thereby opening the vehicle door;

When the vehicles collide, the inertial locking device is first rotated by the inertial action of the collision, so that the first limiting protrusion on the inertial locking device and the second limiting protrusion on the handle unlocking device interfere with each other, thereby limiting the handle unlocking device to rotate to drive the unlocking pull rope to unlock, thereby achieving the effect of locking the vehicle door.

The beneficial effects of the present disclosure lie in that: By means of the inertial locking device, the rotational unlocking of the handle unlocking device can be restricted when the vehicles collide, so that the door is locked when the collision occurs, thereby ensuring safety of persons in the vehicle, simplifying the structure, facilitating installation and high reliability.

### BRIEF DESCRIPTION OF THE DRAWINGS

FIG. 1 is an exploded view of the present disclosure.

FIG. 2 is a structural model view of a normal opening door of the present disclosure.

FIG. 3 is a structural model view of the present disclosure when a vehicle collides.

### DETAILED DESCRIPTION OF THE EMBODIMENTS

Hereinafter, the present disclosure will be further described in detail with reference to the accompanying drawings and specific embodiments.

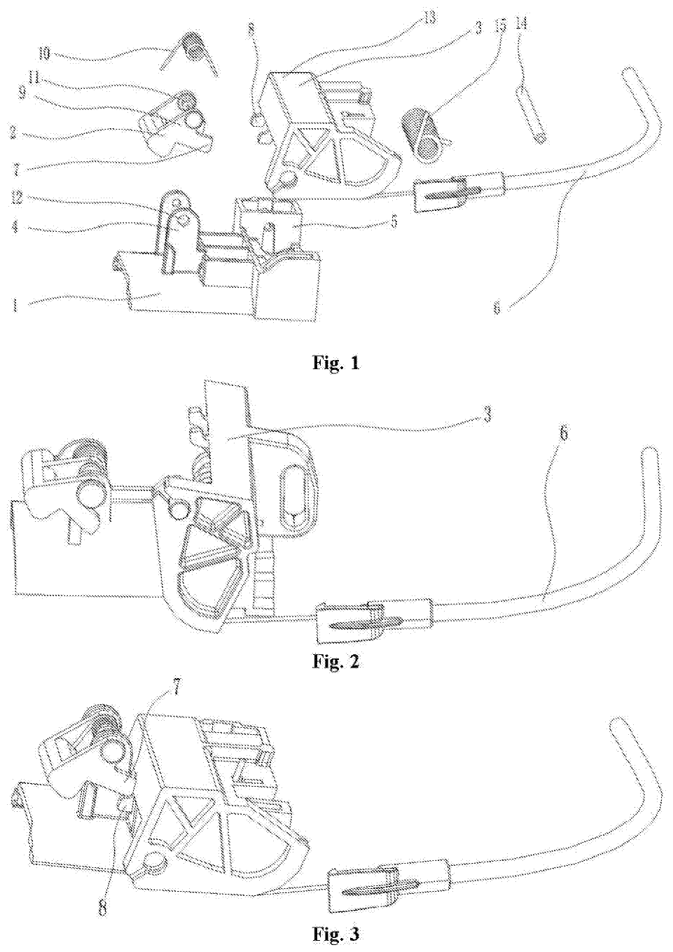

Referring to FIGS. 1-3, a vehicle handle inertial locking structure includes a handle base 1, and the vehicle handle inertial locking structure further includes an inertial locking device 2 and a handle unlocking device 3. The handle base 1 is provided with a first bracket 4 located on a left side and a second bracket 5 located on a right side. The inertial locking device 2 is rotatably connected to the first bracket 4, and the handle unlocking device 3 is rotatably connected to the second bracket 5, and the vehicle handle inertial locking structure further includes an unlocking pull rope 6, one end of the unlocking rope 6 is connected to the handle unlocking device 3, and the other end is connected to an internal locking body of the vehicle. When the handle unlocking device rotates, the unlocking pull rope is pulled to implement an unlocking of a handle, thereby opening the vehicle door;

The inertial locking device 2 is provided with a first limiting protrusion 7, the handle unlocking device 3 is provided with a second limiting protrusion 8, and the first limiting protrusion 7 corresponds to the second limiting protrusion 8, and when the vehicles collide, the inertial locking device 2 is rotated first by the inertial action of the collision. Thus, the first limiting protrusion 7 on the inertial locking device 2 and the second limiting protrusion 8 on the handle unlocking device 3 interfere with each other, thereby limiting the handle unlocking device 3 from rotating to drive the unlocking pull rope 6 to unlock, thereby achieving the effect of locking the door switch.

In the present embodiment, the inertial locking device 2 includes an inertial locking body 9 and a first torsion spring 10, and the inertial locking body 9 is rotatably connected to the first bracket 4, and the first torsion spring 10 is arranged on the inertial locking body 9. And after the vehicles collision is finished, the inertial locking body 9 is reset under the action of the first torsion spring 10, and at this time, the door is in an open able state.

In this embodiment, the inertial lock body 9 is provided with a positioning shaft 11, the positioning shaft 11 is sleeved with the first torsion spring 10, the first bracket 4 is provided with a positioning hole 12, and the positioning shaft 11 can be inserted into the positioning hole 12. Multiple rotations of the inertial locking body 9 can be achieved by positioning structure and combining the first torsion spring 10.

In the present embodiment, the handle unlocking device 3 includes an unlocking piece 13, a rotating shaft 14 and a second torsion spring 15, the unlocking piece 13 is rotatably connected to the second bracket 5 by the rotating shaft 14, the second torsion spring 15 is sleeved on the rotating shaft 14, and the working end of the second torsion spring 15 abuts against the unlocking piece 13. The unlocking function can be implemented by rotating the rotating shaft 14 and the unlocking piece 13, and the reset function is implemented by the second torsion spring 15 after the unlocking is completed.

This embodiment is only one of the preferable solutions of the present patent, and all changes made without departing from the scope of the present technical solution are within the scope of the present patent.

What is claimed is:

1. An vehicle handle inertial locking structure comprising a handle base, wherein the vehicle handle inertial locking structure further comprises an inertial locking device and a handle unlocking device, wherein the handle base is provided with a first bracket located on a left side and a second bracket located on a right side, the inertial locking device is rotatably connected to the first bracket, and the handle unlocking device is rotatably connected to the second bracket, and the vehicle handle inertial locking structure further comprises an unlocking pull rope; wherein one end of the unlocking pull rope is connected to the handle unlocking device, and the other end of the unlocking pull rope is connected to an internal locking body of a vehicle; when the handle unlocking device rotates, the unlocking pull rope is pulled to implement an unlocking of a handle, thereby opening a vehicle door;
wherein the inertial locking device is provided with a first limiting protrusion, the handle unlocking device is provided with a second limiting protrusion, the first limiting protrusion corresponds to the second limiting protrusion, and when the inertial locking device rotates counterclockwise, the first limiting protrusion interferes with the second limiting protrusion; thus, the inertial locking device restricts a rotation of the handle unlocking device and cannot implement an unlocking of the handle.

2. The vehicle handle inertial locking structure as claimed in claim 1, wherein the inertial locking device comprises:
an inertial locking body; and
a first torsion spring, wherein the inertial locking body is rotatably connected to the first bracket, and the first torsion spring is arranged on the inertial locking body.

3. The vehicle handle inertial locking structure as claimed in claim 2, wherein the inertial locking body is provided with a positioning shaft, the first torsion spring is provided on the positioning shaft in a sleeve manner, the first bracket is provided with a positioning hole, and the positioning shaft can be inserted into the positioning hole.

4. The vehicle handle inertial locking structure as claimed in claim 1, wherein the handle unlocking device comprises:
an unlocking piece;
a rotating shaft; and
a second torsion spring, wherein the unlocking piece is rotatably connected to the second bracket by the rotating shaft, the second torsion spring is provided on the rotating shaft in a sleeve manner, and a working end of the second torsion spring abuts against the unlocking piece.
